(19) United States
(12) Patent Application Publication
(10) Pub. No.: US 2013/0287107 A1
(43) Pub. Date: Oct. 31, 2013

(54) IMAGE CODING APPARATUS, IMAGE CODING METHOD AND PROGRAM, IMAGE DECODING APPARATUS, AND IMAGE DECODING METHOD AND PROGRAM

(71) Applicant: Masato Shima, Tokyo (JP)

(72) Inventor: Masato Shima, Tokyo (JP)

(73) Assignee: CANON KABUSHIKI KAISHA, Tokyo (JP)

(21) Appl. No.: 13/979,468

(22) PCT Filed: Jan. 12, 2012
(86) PCT No.: PCT/JP2012/000137

§ 371 Date: Jul. 12, 2013

(30) Foreign Application Priority Data
Jan. 13, 2011 (JP) 2011-004646

(51) Int. Cl. H04N 7/32

(52) U.S. Cl. CPC H04N 19/00569
USPC 375/240.12

(57) ABSTRACT

An image coding method according to one aspect includes dividing an input image into processing target block(s), determining a mode of an intra-picture prediction of the processing target block in units of the divided processing target block(s), holding the prediction mode into a holding unit, estimating the intra prediction mode of the processing target block, comparing the result of the prediction mode determination and the result of the prediction mode estimation to determine whether they match each other, coding the result of the comparison, and further, when the result of the comparison indicates a mismatch, coding the result of the prediction mode determination. An intra prediction mode of one or more predetermined processing units surrounding the processing target block from the holding unit is acquired and compared, and the coding is controlled based on the result of the mode comparison.

### TECHNICAL FIELD

The present invention relates to an image coding apparatus, an image coding method and a program, an image decoding apparatus, and an image decoding method and a program, and in particular, to an intra-picture prediction coding method in an image.

### BACKGROUND ART

There is known a method for recording a moving image while compressing it such as H.264/Moving Picture Experts Group-4 Advanced Video Coding (MPEG-4 AVC) (hereinafter referred to as “H.264”) (International Organization for Standardization/International Electrotechnical Commission (ISO/IEC) 14496-10: 2004, “Information technology—Coding of audio-visual objects—Part 10: Advanced Video Coding”). The H.264 coding method is widely used in, for example, one-segment digital terrestrial broadcasting. The H.264 coding method is characterized in that this method performs an integer transform per unit of four-by-four pixels and prepares a plurality of types of intra predictions (intra-picture predictions), in addition to the conventional coding method. Other characteristics of the H.264 coding method are that this method uses a loop filter, allows reference to a plurality of previous and subsequent frames, and provides motion compensation with use of seven types of sub blocks. Further, as is the case with the MPEG-4 method, the H.264 coding method can perform motion compensation with quarter pixel precision. Further, the H.264 coding method is characterized by use of, for example, universal variable length coding and context-adaptive variable length coding as entropy coding (“H.264: Advanced video coding for generic audiovisual services” published by International Telecommunication Union Telecommunication Standardization Sector (ITU-T))

The H.264 method has a plurality of modes for an intra prediction, and therefore bits should be assigned and coded for intra prediction mode information for identification of a selected mode as side information. For example, an intra prediction predicts a block from the surrounding blocks for each block constituted by four-by-four pixels in a macro block, and further estimates the prediction mode of the pixel block from the prediction modes of the surrounding blocks. Then, one bit is assigned to a flag (prev_intra4×4_pred_mode_flag) indicating a match/mismatch between the predicted mode and the estimated mode. Subsequently, in a case where the predicted mode does not match the estimated mode, three bits are assigned to a flag (rem_intra4×4_pred_mode) indicating the predicted mode for each block.

### CITATION LIST

### Non Patent Literature

NPL 1: International Organization for Standardization/International Electrotechnical Commission (ISO/IEC) 14496-10: 2004, “Information technology—Coding of audio-visual objects—Part 10: Advanced Video Coding”
NPL 2: “H.264: Advanced video coding for generic audiovisual services” published by International Telecommunication Union Telecommunication Standardization Sector (ITU-T)

### SUMMARY OF INVENTION

The present invention is directed to realizing highly efficient coding/decoding of intra prediction mode information by reducing a coded amount required for identification of a mode.

According to an aspect of the present invention, an image coding apparatus includes a division unit configured to divide an input image into a processing target block, a prediction mode determination unit configured, in units of the processing target block divided by the division unit, to determine a mode of an intra-picture prediction of the processing target block, a holding unit configured to hold the intra prediction mode determined by the prediction mode determination unit, a prediction mode estimation unit configured to estimate the intra prediction mode of the processing target block based on an intra prediction mode of a surrounding block around the processing target block, which are held by the holding unit, a determination unit configured to determine whether the result of the prediction mode determination unit and the result of the prediction mode estimation unit match each other, a coding unit configured to code the result of the determination unit, and further, when the result of the determination unit indicates a mismatch, code the result of the prediction mode determination unit, a mode comparison unit configured to acquire an intra prediction mode of one or more predetermined processing unit surrounding the processing target block from the holding unit to compare the modes, and a control unit configured to control the coding unit based on the result of the mode comparison unit.

According to the aspect of the present invention, it is possible to realize highly efficient coding/decoding of intra prediction mode information by referring to the intra prediction modes of the inside or vicinity of a processing unit and omitting unnecessary coding to reduce a coded amount required for mode identification.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating the configuration of an image coding apparatus according to a first exemplary embodiment.

FIG. 2 is a block diagram illustrating the detailed configuration of a mode determination/coding unit.

FIG. 3 illustrates an example of the arrangement of processing units in a block.

FIG. 4 is a flowchart illustrating the image coding processing performed by the image coding apparatus according to the first exemplary embodiment.

FIG. 5 is a flowchart illustrating the detailed processing of step S402 according to the first exemplary embodiment.

FIG. 6 is a flowchart illustrating the detailed processing of step S402 according to a second exemplary embodiment.

FIG. 7 is a block diagram illustrating the configuration of an image decoding apparatus according to a third exemplary embodiment.

FIG. 8 is a block diagram illustrating the detailed configuration of an intra prediction mode decoding unit.

FIG. 9 is a flowchart illustrating the image decoding processing performed by the image decoding apparatus according to the third exemplary embodiment.

FIG. 10 is a flowchart illustrating the detailed processing of step S902 according to the third exemplary embodiment.

FIG. 11 is a flowchart illustrating the detailed processing of step S902 according to a fourth exemplary embodiment.

FIG. 12 is a block diagram illustrating an example of the hardware configuration of a computer applicable to the image coding apparatus and the image decoding apparatus according to the exemplary embodiments of the present invention.

FIG. 13A illustrates an example of a coded data arrangement according to the exemplary embodiments of the present invention or a conventional technique.

FIG. 13B illustrates an example of a coded data arrangement according to the exemplary embodiments of the present invention or a conventional technique.

FIG. 13C illustrates an example of a coded data arrangement according to the exemplary embodiments of the present invention or a conventional technique.

FIG. 13D illustrates an example of a coded data arrangement according to the exemplary embodiments of the present invention or a conventional technique.

FIG. 14 illustrates an example of the arrangement of processing units in a block.

### DESCRIPTION OF EMBODIMENTS

Various exemplary embodiments, features, and aspects of the invention will be described in detail below with reference to the drawings.

The configurations of exemplary embodiments which will be described below are merely an example, and the present invention is not limited to the illustrated configurations.

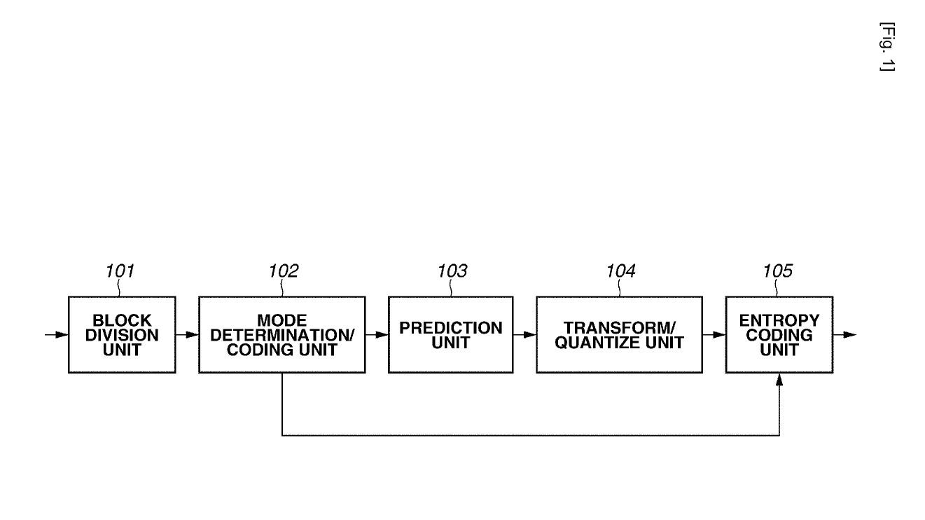

A first exemplary embodiment will be described. In the following, the present exemplary embodiment will be described with reference to the drawings. FIG. 1 is a block diagram illustrating an image coding apparatus to which the present invention is applied.

Referring to FIG. 1, a block division unit 101 divides an input video image into a plurality of blocks. A mode determination/coding unit 102 determines, for each of the divided blocks, a size of a processing unit, which will be a unit of prediction and is the same as or smaller than the block in size. Further, the mode determination/coding unit 102 determines an intra prediction mode (intra-picture prediction mode) of each processing unit and then codes the intra prediction mode. A prediction unit 103 performs an intra prediction by processing unit based on the determined intra prediction mode. A transform/quantization unit 104 transforms and quantizes the difference between the input video image and the prediction. An entropy coding unit 105 codes the result of the transform/quantization unit 104.

In the following, the image coding operation of the image coding apparatus will be described. For convenience of description, the present exemplary embodiment will be described focusing on only intra prediction coding processing, but this does not limit the present exemplary embodiment. The present exemplary embodiment can be also applied to inter prediction coding processing.

Input image data corresponding to one frame is input into the block division unit 101 to be divided in units of block, and then is output to the mode determination/coding unit 102. The mode determination/coding unit 102 first determines, for the image data divided in units of block, whether a size of a processing unit, which will be a unit of prediction, should be set to smaller than or the same as the block in size, by dividing the block.

Subsequently, the mode determination/coding unit 102 determines an intra prediction mode for the determined processing unit, and codes the determined intra prediction mode. The determined intra prediction mode is output into the prediction unit 103, and the coded data is output to the entropy coding unit 105. The intra prediction mode determined by the mode determination/coding unit 102 is input into the prediction unit 103, which performs a prediction by determined processing unit. The difference between the input image and the prediction is input into the transform/quantization unit 104, and is transformed and quantized therein. The quantized coefficient data is transmitted to the entropy coding unit 105 to be entropy-coded therein, and after that, is output together with the coded data of the intra prediction mode.

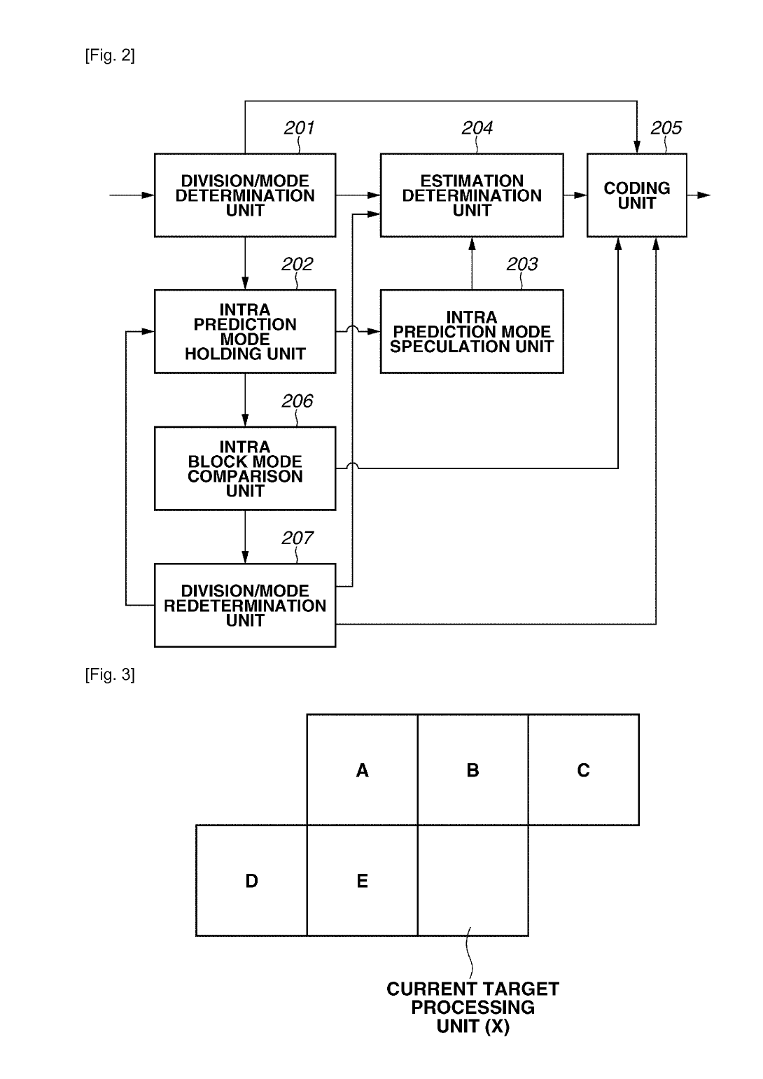

FIG. 2 is a detailed block diagram illustrating the mode determination/coding unit 102 to which the present invention is applied. A division/mode determination unit 201 receives image data divided in units of block as an input, and determines an optimum size of a processing unit, which will be a unit of prediction. Further, the division/mode determination unit 201 determines an optimum intra prediction mode for each processing unit. Generally, the method for determining an optimum intra prediction mode may be calculating a prediction value according to each intra prediction mode and determining the intra prediction mode from the mode that generates a prediction value closest to an input pixel. However, any method can be used to determine an optimum intra prediction mode.

An intra prediction mode holding unit 202 holds the information of the intra prediction mode determined by the division/mode determination unit 201. An intra prediction mode estimation unit 203 acquires intra prediction modes of processing units surrounding the current target processing unit from the intra prediction mode holding unit 202, and estimates the intra prediction mode of the current target processing unit. A estimation determination unit 204 compares the result of the intra prediction mode determination unit 201 or the result of a division/mode redetermination unit 207, which will be described later, with the result of the intra prediction mode estimation unit 203 to determine whether they match each other.

A coding unit 205 codes the result of the estimation determination unit 204, and further codes the result of the division/mode determination unit 201 in a case where the result of the estimation determination unit 204 indicates a mismatch. An intra-block mode comparison unit 206 acquires intra prediction modes of predetermined surrounding processing units belonging to each block unit divided by the block division unit 101 from the intra prediction mode holding unit 202, and compares the intra prediction modes of the surrounding processing units with one another. A division/mode redetermination unit 207 re-determines the size of the processing unit and the intra prediction mode in the block based on the result of the intra-block mode comparison unit 206.

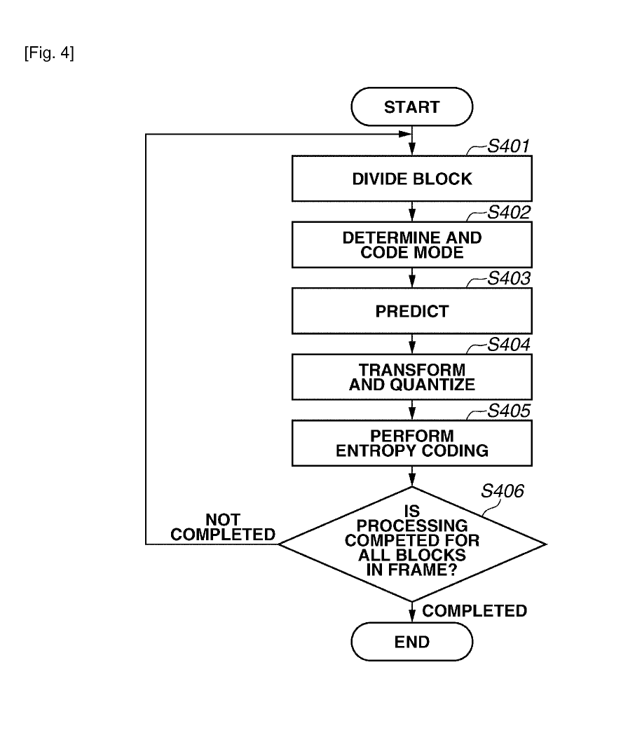

FIG. 3 illustrates an example of an arrangement of processing units for use in a estimation of an intra prediction mode. This example will be described assuming that the coding method is the H.264 method, but this does not limit the present invention. According to the H.264 method, if X represents a current target processing unit to be coded, the intra prediction mode of the processing unit X is estimated from the intra prediction modes of a processing unit B located immediately above the processing unit X, and a processing unit E located on the left of the processing unit X. If the processing units B and E have the same prediction mode (mode 0) that performs a prediction from an upper pixel, the intra prediction mode of the current target processing unit X is estimated as the same prediction mode that performs a prediction from an upper pixel, i.e., the mode 0.

Returning to FIG. 2, the estimation determination unit 204 receives, as inputs, the output result of the division/mode determination unit 201 or the division/mode redetermination unit 207 which will be described later, and the output result of the intra prediction mode estimation unit 203 to compare them, and then outputs the information indicating whether they match each other to the coding unit 205. The estimation determination unit 204 compares the output result of the division/mode redetermination unit 207 and the result of the intra prediction mode estimation unit 203, in a case where the output result of the division/mode redetermination unit 207, which will be described later, indicates that the block is re-divided and the resetting of the intra prediction mode is performed.

The intra-block mode comparison unit 206 reads the results of the intra prediction modes of the surrounding processing units belonging to the same block from the intra prediction mode holding unit 202, and compares them. For example, referring to FIG. 3, if the processing units A, B, E, and X belong to the same block, the intra-block mode comparison unit 206 compares the intra prediction modes of the processing unit A located on the upper left of the processing unit X, the processing unit B located immediately above the processing unit X, and the processing unit E located on the left of the processing unit X, when coding of the processing unit X is performed. The intra-block mode comparison unit 206 generates surrounding mode matching information indicating that they match one another if these surrounding processing units are the same intra prediction mode, or indicating that they do not match one another if there is even one different intra prediction mode among them. The generated surrounding mode matching information is output to the coding unit 205.

One example of the processing order in which processing units in a block are processed will be described now. For example, referring to FIG. 3, if the processing units A, B, E, and X belong to the same block, the upper left processing unit A, the upper right processing unit B, the lower left processing unit E, and the lower right processing unit X are processed in this order. More specifically, the coding unit 205 operates according to the following control method. The coding unit 205 performs control so as to code the matching information, which is the output of the estimation determination unit 204, if the current target processing unit is not the final processing unit in one block unit (the processing units A, B, and E in FIG. 3). Further, in addition to this control, the coding unit 205 performs control so as to code the index indicating the intra prediction mode, which is the output of the division/mode determination unit 201, if the matching information indicates a mismatch. This coding is omitted, if the matching information indicates a match.

On the other hand, if the current target processing unit is the final processing unit in one block unit, and the surrounding mode matching information, which is the output of the intra-block mode comparison unit 206, indicates a mismatch, the coding unit 205 processes this processing unit in the same manner as the above-described processing for a processing unit that is not a final processing unit. In other words, the coding unit 205 performs control to code the matching information, which is the output of the estimation determination unit 204. Further, in addition to this coding, the coding unit 205 performs control to code the index indicating the intra prediction mode, which is the output of the division/mode determination unit 201, if the matching information indicates a mismatch. This coding is omitted, if the matching information indicates a match.

On the other hand, if the current target processing unit is the final processing unit in one block unit, and the surrounding mode matching information, which is the output of the intra-block mode comparison unit 206, indicates a match, the coding unit 205 performs control in the following manner. The coding unit 205 performs control to code the index indicating the intra prediction mode, which is the output of the division/mode determination unit 201, without coding the matching information, which is the output of the estimation determination unit 204.

The coding unit 205 codes the matching information as a prediction mode flag, and codes information required for identification of the intra prediction mode as a prediction mode index if necessary.

On the other hand, the division/mode redetermination unit 207 receives an input of intra-block mode matching information, which is the output of the intra-block mode comparison unit 206, and re-determines the division of processing units in the block and the intra prediction mode. More specifically, the division/mode redetermination unit 207 makes a redetermination so that an intra prediction is performed based on the same size as the size of the block without a division of the block to which the current target processing unit belongs, if the current target processing unit is the final processing unit in one block, and the intra-block mode matching information indicates a match. Further, the division/mode redetermination unit 207 performs resetting of the division of processing units in the block and the intra prediction mode to use the intra prediction that matches in the block. The information of the intra prediction mode, in which resetting is performed, is output to the intra prediction mode holding unit 202, the estimation determination unit 204, and the coding unit 205. In the following, the flow of the coding processing will be described with reference to the drawings.

FIG. 4 is a flowchart illustrating the image coding processing performed by the image coding apparatus according to the first exemplary embodiment. In step S401, the block division unit 101 divides an input image in frame unit into block units. In step S402, the mode determination/coding unit 102 determines, for each of the divided blocks, a size of a processing unit, which will be a unit of prediction and is the same as or smaller than the block in size. Further, the mode determination/coding unit 102 determines and codes the intra prediction mode of each processing unit.

In step S403, the prediction unit 103 performs a prediction based on the intra prediction mode determined in step S402. In step S404, the transform/quantization unit 104 calculates the difference between the input image and the prediction, and transforms and quantizes the result thereof. Further, in step S405, the entropy coding unit 105 applies entropy coding to the quantized coefficient. In step S406, the image coding apparatus determines whether coding is completed for all of the blocks in the frame. If the coding is completed for all of the blocks in the frame (COMPLETED in step S406), all operations are stopped and the processing is ended. If the coding is not completed for all of the blocks in the frame (NOT COMPLETED in step S406), the processing proceeds to step S401 again with the next block set as the next processing target.

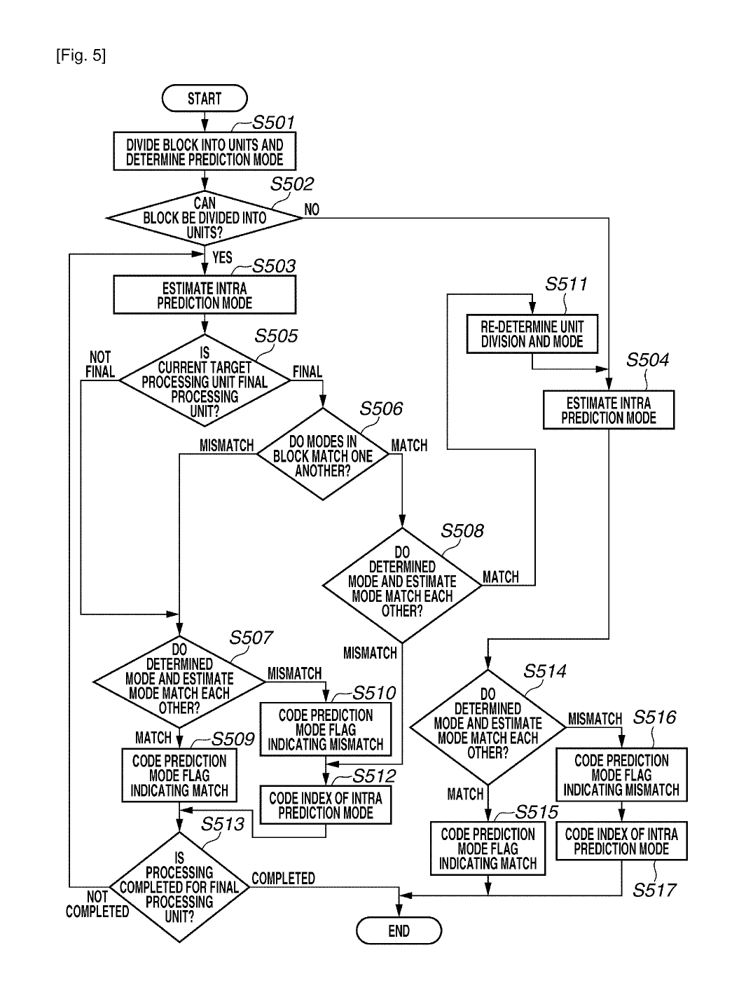

FIG. 5 is a flowchart illustrating the detailed processing of step S402 according to the first exemplary embodiment. In step S501, the mode determination/coding unit 102 determines, for a block that is a current coding target, an optimum size of a processing unit, which will be a unit prediction, and an optimum intra prediction mode of each processing unit. The intra prediction mode is determined from, for example, the characteristics of surrounding pixel values or pixel values in the block to be coded.

In step S502, the mode determination/coding unit 102 determines whether the current target block to be coded can be divided into a plurality of processing units as a result of step S501. If the division is possible (YES in step S502), the processing proceeds to step S503. If the division is impossible (NO in step S502), the processing proceeds to step S504.

In step S503, the mode determination/coding unit 102 estimates the intra prediction mode of the current target processing unit to be coded from the intra prediction modes of the surrounding processing units.

In step S505, the mode determination/coding unit 102 determines whether the current target processing unit to be coded is the final processing unit in the block. If this processing unit is the final processing unit (FINAL in step S505), the processing proceeds to step S506. If this processing unit is not the final processing unit (NOT FINAL in step S505), the processing proceeds to step S507.

In step S506, the mode determination/coding unit 102 determines whether all of the previously coded processing units in the block have the same intra prediction mode. If their intra prediction modes match one another (MATCH in step S506), the processing proceeds to step S508. If there is a different intra prediction mode among them (MISMATCH in step S506), the processing proceeds to step S507.

In step S507, the mode determination/coding unit 102 determines whether the intra prediction mode determined in step S501 matches the intra prediction mode estimated in step S503. If they match each other (MATCH in step S507), the processing proceeds to step S509. If they do not match each other (MISMATCH in step S507), the processing proceeds to step S510.

In step S508, the mode determination/coding unit 102 determines whether the intra prediction mode determined in step S501 matches the intra prediction mode estimated in step S503, in the same manner as step S507. If they match each other (MATCH in step S508), the processing proceeds to step S511. If they do not match each other (MISMATCH in step S508), the processing proceeds to step S512.

In step S509, the mode determination/coding unit 102 codes the prediction mode flag indicating a match. In step S510, the mode determination/coding unit 102 codes the prediction mode flag indicating a mismatch. After that, the processing proceeds to step S512.

In step S512, the mode determination/coding unit 102 codes the index for identification of the intra prediction mode, and then the processing proceeds to step S513. On the other hand, in step S509, after the mode determination/coding unit 102 codes the prediction mode flag indicating a match, the processing proceeds to step S513.

In step S513, the mode determination/coding unit 102 determines whether coding is completed for all of the processing units in the block. If the coding is completed for all of the processing units in the block (COMPLETED in step S513), all operations are stopped and the processing is ended. If the coding is not completed for all of the processing units in the block (NOT COMPLETED in step S513), the processing proceeds to step S503 again with the next processing unit in the block set as the next target.

In step S511, the mode determination/coding unit 102 resets the size of the processing unit to the same size as the size of the block, and resets the intra prediction mode to the intra prediction modes of the processing units in the block, which match one another in step S506. Then, the processing proceeds to step S504.

On the other hand, in a case where the mode determination/coding unit 102 determines that the current target block to be coded cannot be divided into a plurality of processing units in step S502 (NO in step S502), the mode determination/coding unit 102 performs the following processing. In step S504, the mode determination/coding unit 102 estimates the intra prediction mode of the processing unit to be coded from the intra prediction modes of the surrounding processing units as the target processing unit which are the same as the block to be coded in size.

In step S514, the mode determination/coding unit 102 determines whether the intra prediction mode determined in step S501 matches the intra prediction mode estimated in step S504. If they match each other (MATCH in step S514), the processing proceeds to step S515. If they do not match each other (MISMATCH in step S514), the processing proceeds to step S516.

In step S515, the mode determination/coding unit 102 codes the prediction mode flag indicating a match, and after that, the processing is ended. On the other hand, in step S516, the mode determination/coding unit 102 codes the prediction mode flag indicating a mismatch. Then, in step S517, the mode determination/coding unit 102 codes the index for identification of the intra prediction mode. After that, the processing is ended.

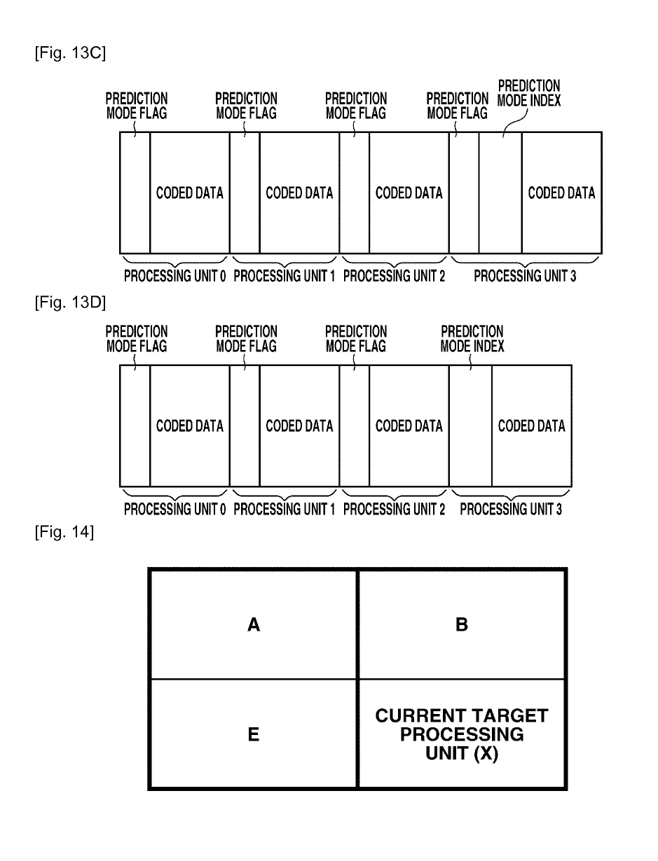

FIG. 13A illustrates an example of a coded data arrangement encoded according to a conventional coding method such as the H.264 method. On the other hand, FIG. 13B illustrates a corresponding example of a coded data arrangement encoded according to the present invention. In the example, intra prediction modes of all the processing units in a block are assumed to be the same, so that the number of bits corresponding to the prediction mode flags can be reduced except for the prediction mode flag of the first processing unit in the block.

Further, FIG. 13C illustrates another example of a coded data arrangement encoded according to a conventional coding method such as the H.264 method. On the other hand, FIG. 13D illustrates a corresponding example of a coded data arrangement encoded according to the present invention. In the example, it is assumed that intra prediction modes of all the processing units except for the final processing unit in a block are the same, but only the final processing unit has a different intra prediction mode. Accordingly, the number of bits corresponding to the prediction mode flag of the final processing unit in the block can be reduced.

In the present exemplary embodiment, the intra prediction mode estimation unit 203 estimates the intra prediction mode of a processing unit to be coded from adjacent processing units, but this does not limit the present exemplary embodiment. For example, as illustrated in FIG. 3, when the processing unit X is the coding target, the intra prediction mode estimation unit 203 may estimate the intra prediction mode of the processing unit X by also taking into consideration the intra prediction mode of the processing unit C located on the right of the processing unit above the processing unit X, and even the intra prediction modes of processing units that are not adjacent to but surrounding the processing unit X, such as the processing unit D located on the left of the processing unit E.

The present exemplary embodiment has been described based on an example of a frame using only an intra prediction, but it is obvious that the present exemplary embodiment can be also applied to a frame capable of using an inter prediction.

Further, in the present exemplary embodiment, block sizes have been described based on two types, i.e., the type that a block is divided and the type that a block is not divided. However, this does not limit the present exemplary embodiment. The processing unit may be further divided. Further, the shape of a block is not limited to the described and illustrated one, and the present exemplary embodiment keeps its essence unchanged, even if a block has a rectangular shape, or there is an overlap portion between blocks.

A second exemplary embodiment will be described. The second exemplary embodiment will be described as a modification of the first exemplary embodiment. A difference between the first exemplary embodiment and the second exemplary embodiment is that, in the second exemplary embodiment, the intra prediction mode estimation unit 203 outputs the estimated intra prediction mode to not only the estimation determination unit 204 but also the intra-block mode comparison unit 206 (not illustrated). In the following, the coding operation of the mode determination/coding unit 102 will be described. Referring to FIG. 2, the operations of the division/mode determination unit 201 and the intra prediction mode holding unit 202 are the same as those in the first exemplary embodiment, and therefore the descriptions thereof will be omitted here. The intra prediction mode estimation unit 203 inputs the information of the intra prediction modes of predetermined surrounding processing units around the current target processing unit to estimate the intra prediction mode of the current target processing unit, from the intra prediction mode holding unit 202. The intra prediction mode estimation unit 203 estimates the intra prediction mode of the current target processing unit from the intra prediction modes of the surrounding processing units, and outputs the result thereof to the estimation determination unit 204 and the intra-block mode comparison unit 206.

The intra-block mode comparison unit 206 first inputs the intra prediction modes of predetermined surrounding processing units around the current target processing unit from the intra prediction mode holding unit 202. In addition to this input, the intra-block mode comparison unit 206 also inputs the estimated intra prediction mode of the current target processing unit, which is the result of the intra prediction mode estimation unit 203. The intra-block mode comparison unit 206 outputs estimated/surrounding mode matching information, which is information indicating whether the input intra prediction modes match one another, to the coding unit 205. In other words, the estimated/surrounding mode matching information indicates a match when the intra prediction modes match one another among the predetermined surrounding processing units around the current target processing unit as is the case with the first exemplary embodiment, and further, the estimated intra prediction mode of the current target processing unit also matches them. The matching information indicates a mismatch when any of them, even only one of them has a different intra prediction mode.

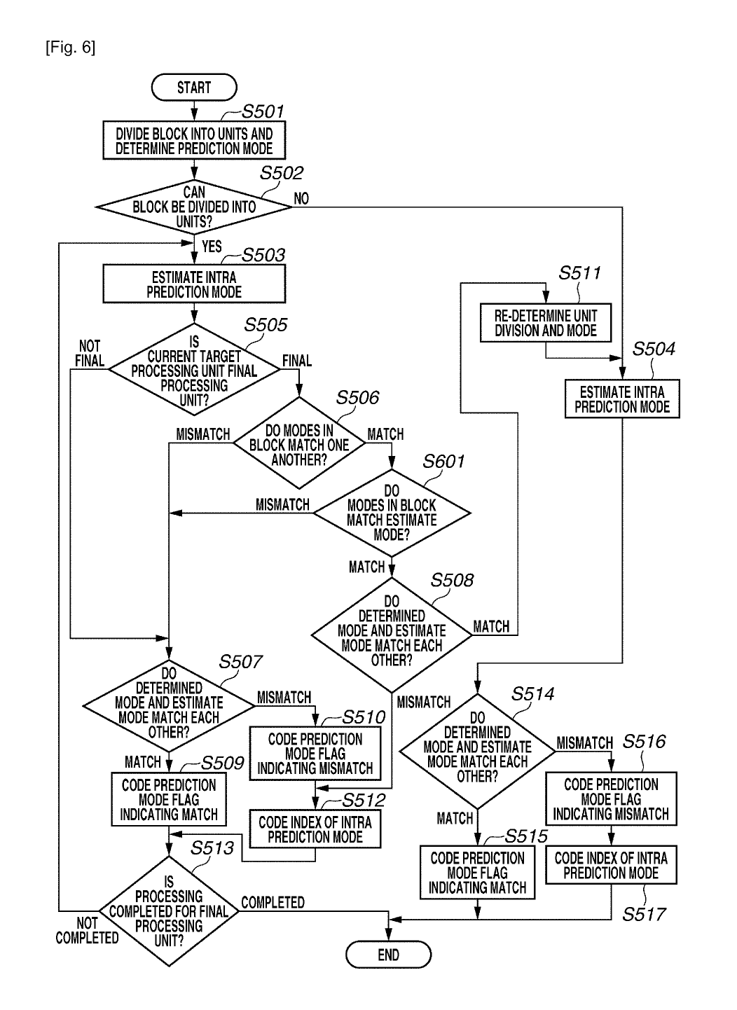

Unlike the first exemplary embodiment, the coding unit 205 receives the estimated/surrounding mode matching information (match/mismatch) instead of the surrounding mode matching information (match/mismatch) in the first exemplary embodiment, but the operation thereof is the same as that of the first exemplary embodiment. Further, the intra-block mode comparison unit 206 reads out the intra prediction modes of the processing units belonging to the same block from the intra prediction mode holding unit 202, generates the intra-block mode matching information, and outputs it to the division/mode redetermination unit 207. The processing of step S402 according to the second exemplary embodiment will be more specifically described with reference to the drawings. FIG. 6 is a flowchart illustrating the detailed processing of step S402 according to the second exemplary embodiment.

The steps except for steps S506 and S601 are the same as those in the first exemplary embodiment, and therefore the descriptions thereof will be omitted here. In step S506, the mode determination/coding unit 102 determines whether the intra prediction modes match one another among the already coded processing units in the block. If they match one another (MATCH in step S506), the processing proceeds to step S601. If they do not match one another (MISMATCH in step S506), the processing proceeds to step S507.

In step S601, the mode determination/coding unit 102 determines whether the intra prediction modes of the already coded processing units in the block, which match one another, further match the intra prediction mode of the processing unit estimated in step S503. If they match each other (MATCH in step S601), the processing proceeds to step S508. If they do not match each other (MISMATCH in step S601), the processing proceeds to step S507.

The above-described configuration and operation can reduce the amount of bits required for identification of an intra prediction mode, as is the case with the first exemplary embodiment. Further, it is possible to solve a problem arising when a block is divided into a small number of processing units, and the intra prediction mode of the final processing unit is estimated by referring to the intra prediction mode of a processing unit outside the corresponding block. More specifically, for example, when a block is divided into processing units as illustrated in FIG. 14, i.e., a block defined by the thick line is constituted by rectangular processing units B and X, the intra-block mode matching information should always indicate a match, since this information is generated by referring to only the processing unit B. Further, the intra prediction mode of the current target processing unit X is determined by referring to the processing unit B. On the other hand, the intra prediction mode of the current target processing unit X is estimated by referring to the intra prediction mode of the processing unit E outside the block and the intra prediction mode of the processing unit B. In this case, there is a possibility that the referred processing unit used for intra prediction mode determination may be different from that used for intra prediction mode estimation when processing unit X is the final processing unit of the block. In other words, the first exemplary embodiment cannot reduce the number of bits, despite that the intra prediction modes in the block match with each other, if there is another processing unit out of the current block used for the intra prediction mode estimation. The present exemplary embodiment can avoid this problem, thereby allowing an effective reduction in the number of bits.

It should be noted that, as is the case with the first exemplary embodiment, processing units that the intra prediction mode estimation unit 203 refers to are not limited to adjacent processing units, and the intra prediction mode estimation unit 203 may refer to the intra prediction mode of a processing unit that is not adjacent to but surrounding a target processing unit.

A third exemplary embodiment will be described. FIG. 7 is a block diagram illustrating the configuration of an image decoding apparatus according to the third exemplary embodiment of the present invention. In the present exemplary embodiment, decoding of coded data generated by the first exemplary embodiment will be described. Referring to FIG. 7, a block decoding unit 701 decodes the information in units of block from an input stream. An intra prediction mode decoding unit 702 decodes the intra prediction mode of each processing unit. An entropy decoding unit 703 decodes the information and coefficient of each of processing units existing in each block. An inverse quantization/inverse transform unit 704 applies inverse quantization and inverse transform to the decoded coefficient. A image data reconstruction unit 705 reconstructs decoded pixel data from the result of the inverse quantization/inverse transform unit 704 and the result of the intra prediction mode decoding unit 702.

In the following, the image decoding operation performed by the image decoding apparatus will be described. Coded data corresponding to one frame is input into the image decoding apparatus, and then data in units of block is input into the block decoding unit 701 one by one, which decodes the information of each block. The block decoding unit 701 outputs coded data of each processing unit, based on the structure of a processing unit determined by the above-described information of each block. This coded data is input into the intra prediction mode decoding unit 702, which decodes the information of the intra prediction mode to output it into the pixel data reconstruction unit 705. On the other hand, the rest of the coded data is output into the entropy decoding unit 703. The entropy decoding unit 703 decodes a coefficient value to output it. The coefficient value is input into the inverse quantization/inverse transform unit 704, which outputs prediction error data through the processes of inverse quantization and inverse transform. The information of the intra prediction mode and the prediction error data are input into the image data reconstruction unit 705, which calculates a prediction value from the information of the intra prediction mode, and reconstructs decoded pixel data by adding the prediction value and the coefficient data to output it.

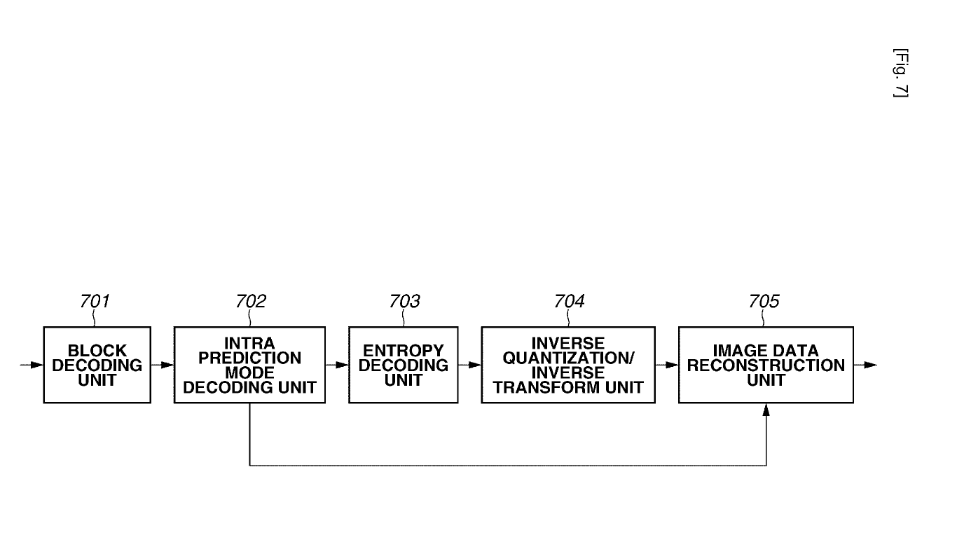

FIG. 8 is a detailed block diagram of the intra prediction mode decoding unit 702 to which the present invention is applied. Referring to FIG. 8, an intra prediction decoding unit 801 decodes an intra prediction mode. A mode holding unit 802 holds the intra prediction mode acquired by decoding. An intra prediction mode estimation unit 803 estimates the intra prediction mode of a processing unit to be decoded from the intra prediction modes of predetermined surrounding processing units. An intra-block mode comparison unit 804 acquires the intra prediction modes of predetermined surrounding processing units from the mode holding unit 802 to compare them. A final processing unit determination unit 805 determines whether a processing unit to be decoded is the final processing unit in the block. This is automatically determined from the decoded state of the block. A decoding control unit 806 controls the operation of the intra prediction decoding unit 801 based on the results of the intra-block mode comparison unit 804 and the final processing unit determination unit 805.

In the following, the decoding operation of the intra prediction mode decoding unit 702 will be described. The intra prediction decoding unit 801 receives coded data of a current target processing unit and the output result of the intra prediction mode estimation unit 803 as inputs, and decodes the intra prediction mode to output it under the control of the decoding control unit 806. The mode holding unit 802 holds the information of the intra prediction mode which is the output of the intra prediction decoding unit 801, and outputs intra prediction mode information of predetermined surrounding processing units to the intra prediction mode estimation unit 803 and the intra-block mode comparison unit 804 as necessary.

The intra prediction mode estimation unit 803 inputs the intra prediction modes of predetermined surrounding processing units around the current target processing unit from the mode holding unit 802 to estimate the intra prediction mode of the processing unit to be decoded, and outputs the intra prediction mode of the current target processing unit estimated from these intra prediction modes to the intra prediction decoding unit 801.

On the other hand, the intra-block mode comparison unit 804 inputs the intra prediction modes of predetermined surrounding processing units around the current target processing unit from the mode holding unit 802, and outputs surrounding mode matching information, which is information indicating whether these modes match one another, to the decoding control unit 806. The final processing unit determination unit 805 determines whether the current target processing unit to be decoded is the final processing unit in the block, and outputs the result of this determination to the decoding control unit 806 as final processing unit information.

The decoding control unit 806 inputs the final processing unit information, which is the output of the final processing unit determination unit 805, and the surrounding mode matching information, which is the output of the intra-block mode comparison unit 804, and controls the operation of the intra prediction decoding unit 801.

First, if the final processing unit information indicates that the current target processing unit to be decoded is not the final processing unit in the block, or if the surrounding mode matching information indicates a mismatch, the decoding control unit 806 controls the intra prediction decoding unit 801 in the following manner. In such a case, first, the intra prediction decoding unit 801 decodes the prediction mode flag, which is the information indicating whether the intra prediction mode of the current target processing unit to be decoded matches the intra prediction mode estimated by the intra prediction mode estimation unit 803, to acquire the matching information.

If the matching information indicates a match, the intra prediction decoding unit 801 outputs the estimated intra prediction mode, which is the output of the intra prediction mode estimation unit 803, as the intra prediction mode of the current target processing unit. On the other hand, if the matching information indicates a mismatch, the intra prediction decoding unit 801 is controlled to further decode the index for identification of the intra prediction mode to calculate the intra prediction mode.

On the other hand, if the final processing unit information indicates that the current target processing unit is the final processing unit in the block, and if the surrounding mode matching information indicates a match, the decoding control unit 806 controls the intra prediction decoding unit 801 in the following manner. The intra prediction decoding unit 801 can assume that the prediction mode flag indicates a mismatch between the intra prediction mode of the current target processing unit and the estimated intra prediction mode, which is the output of the intra prediction mode estimation unit 803. Therefore, the intra prediction decoding unit 801 is controlled to subsequently decode the index for identification of the intra prediction mode to calculate the intra prediction mode.

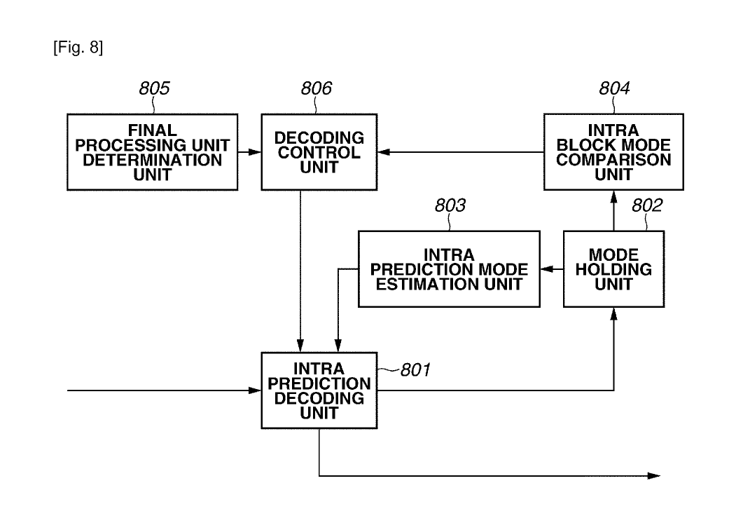

In the following, the flow of the decoding processing will be described with reference to the drawings. FIG. 9 is a flowchart illustrating the image decoding processing performed by the image decoding apparatus according to the third exemplary embodiment.

First, in step S901, the block decoding unit 701 decodes the information in units of block from input coded data. In step S902, the intra prediction mode decoding unit 702 decodes the intra prediction mode of each processing unit existing in each block as a unit of prediction. In step S903, the entropy decoding unit 703 applies entropy decoding to the information and coefficient in units of processing unit.

In step S904, the inverse quantization/inverse transform unit 704 applies inverse quantization and inverse transform to the decoded prediction error. In step S905, the image data reconstruction unit 705 calculates a prediction value from the result of step S902, and calculates a reconstructed pixel by adding the prediction value and the coefficient value which is the result of step S904. In step S906, the image decoding apparatus determines whether decoding is completed for all of the processing units in the block. If decoding is completed for all of the processing units in the block (COMPLETED in step S906), the processing proceeds to step S907. If decoding is not completed for all of the processing units in the block (NOT COMPLETED in step S906), the processing proceeds to step S902 again with the next processing unit in the block set as the next decoding target. In step S907, the image decoding apparatus determines whether decoding is completed for all of the blocks in the frame. If decoding is completed for all of the blocks in the frame (COMPLETED in step S907), all operations are stopped and the processing is ended. If decoding is not completed for all of the blocks in the frame (NOT COMPLETED in step S907), the processing proceeds to step S901 again with the next block in the frame set as the next decoding target.

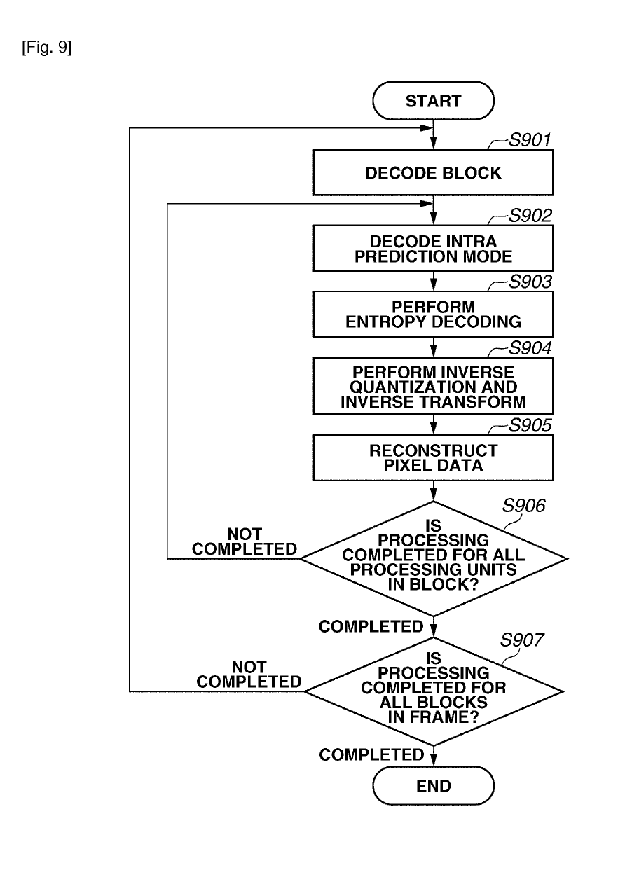

FIG. 10 is a flowchart illustrating the detailed processing of step S902 according to the third exemplary embodiment. In step S1001, the intra prediction mode decoding unit 702 estimates the intra prediction mode of a processing unit to be decoded from the intra prediction modes of the surrounding processing units.

In step S1002, the intra prediction mode decoding unit 702 determines whether the processing unit to be decoded is the final processing unit in the block. If the processing unit to be decoded is the final processing unit (FINAL in step S1002), the processing proceeds to step S1003. If the processing unit to be decoded is not the final processing unit (NOT FINAL in step S1002), the processing proceeds to step S1004.

In step S1003, the intra prediction mode decoding unit 702 determines whether the intra prediction modes match one another among all of predetermined processing units in the block which have been already decoded. If the intra prediction modes match one another among them (MATCH in step S1003), the processing proceeds to step S1006. If the intra prediction modes do not match one another among them (MISMATCH in step S1003), the processing proceeds to step S1004.

In step S1004, the intra prediction mode decoding unit 702 decodes the prediction mode flag which indicates whether the intra prediction mode of the processing unit to be decoded matches the intra prediction mode estimated in step S1001.

In step S1005, the intra prediction mode decoding unit 702 determines whether the prediction mode flag indicates a match. If the prediction mode flag indicates a match (MATCH in step S1005), the processing proceeds to step S1008. If the prediction mode flag indicates a mismatch (MISMATCH in step S1005), the processing proceeds to step S1006.

In step S1006, the intra prediction mode decoding unit 702 decodes the prediction mode index for identification of the intra prediction mode. On the other hand, in step S1008, the intra prediction mode decoding unit 702 sets the prediction mode estimated in step S1001 as the intra prediction mode of the processing unit to be decoded. In step S1007, the intra prediction mode decoding unit 702 determines the intra prediction mode of the processing unit to be decoded based on the result of step S1006 or step S1008, and after that, the processing of decoding the intra prediction mode is ended.

The above-described configuration and operation can decode coded data having a reduced amount of bits required for identification of the intra prediction mode, which is generated according to the first exemplary embodiment.

The present exemplary embodiment has been described based on an example of decoding of a frame using only an intra prediction, but it is obvious that the present exemplary embodiment can be also applied to decoding of a frame capable of using an inter prediction as well.

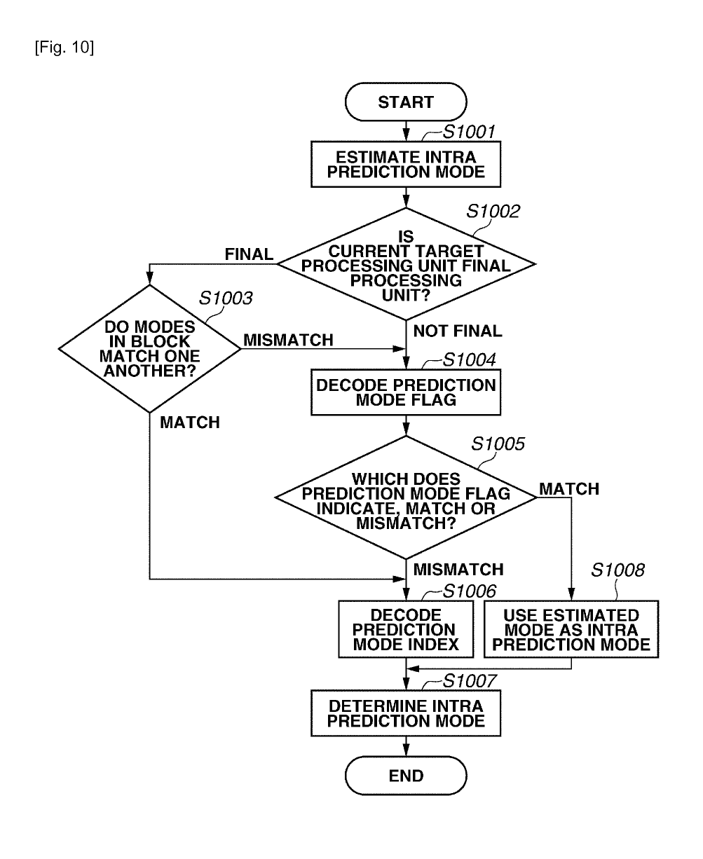

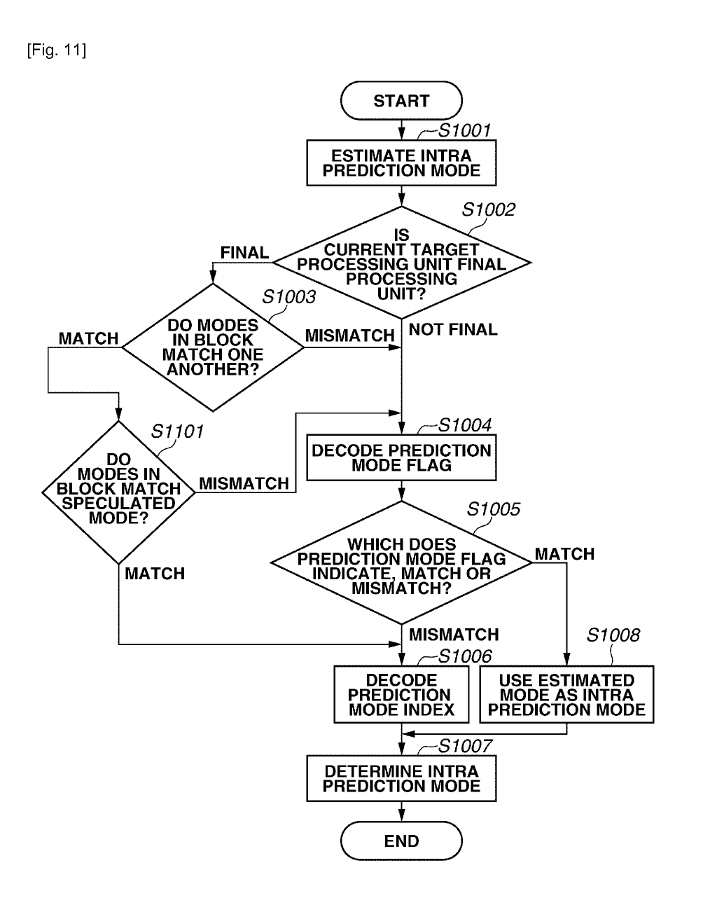

A fourth exemplary embodiment will be described. The present exemplary embodiment will be described as an example decoding coded data generated according to the second exemplary embodiment, with reference to FIG. 11. A difference between the third exemplary embodiment and the fourth exemplary embodiment is that, in the fourth exemplary embodiment, the intra prediction mode estimation unit 803 outputs a estimated intra prediction mode to not only the intra prediction decoding unit 801 but also the intra-block mode comparison unit 804 (not illustrated). In the following, the decoding operation of the intra prediction mode decoding unit 702 according to the fourth exemplary embodiment will be described with reference to FIG. 8. The operations of the intra prediction decoding unit 801 and the mode holding unit 802 are the same as those in the third exemplary embodiment, and therefore the descriptions thereof will be omitted here.

The intra prediction mode estimation unit 803 inputs the intra prediction modes of predetermined surrounding processing units around the current target processing unit from the mode holding unit 802 to estimate the intra prediction mode of the current target processing unit to be decoded. Further, the intra prediction mode estimation unit 803 estimates the intra prediction mode of the current target processing unit from the input intra prediction modes of the predetermined surrounding processing units, and outputs the estimated intra prediction mode to the intra prediction decoding unit 801 and the intra-block mode comparison unit 804.

The intra-block mode comparison unit 804 inputs the intra prediction modes of predetermined surrounding processing units around the current target processing unit to be decoded from the mode holding unit 802. At the same time, the intra-block mode comparison unit 804 also inputs the intra prediction mode of the current target processing unit estimated by the intra prediction mode estimation unit 803, and outputs estimated/surrounding mode matching information, which indicates the estimated intra prediction mode and the intra prediction modes of the predetermined surrounding processing units match each other, to the decoding control unit 806. The operations of the decoding control unit 806 and the final processing unit determination unit 805 are the same as those in the third exemplary embodiment, and therefore the descriptions thereof will be omitted here.

In the following, the flow of the decoding processing will be described with reference to the drawings. The flowchart illustrating the image decoding processing performed by the image decoding apparatus according to the fourth exemplary embodiment is the same as that of the third exemplary embodiment, and therefor the description thereof will be omitted here. FIG. 11 is a flowchart illustrating the detailed processing of step S902 according to the present exemplary embodiment.

The steps other than steps S1003 and S1101 are the same as those in the third exemplary embodiment, and therefor the descriptions thereof will be omitted here.

In step S1003, the intra prediction mode decoding unit 702 determines whether the intra prediction modes match one another among all of the predetermined surrounding processing units in the block which have been already decoded. If the intra prediction modes match one another among them (MATCH in step S1003), the processing proceeds to step S1101. If the intra prediction modes do not match one another among them (MISMATCH in step S1003), the processing proceeds to step S1004.

In step S1101, the intra prediction mode decoding unit 702 determines whether the intra prediction modes of the decoded processing units in the block match the intra prediction mode of the processing unit estimated in step S1001. If they match each other (MATCH in step S1101), the processing proceeds to step S1006. If they do not match each other (MISMATCH in step S1101), the processing proceeds to step S1004. The above-described configuration and operation can decode coded data having a reduced amount of bits required for identification of an intra prediction mode, which is generated according to the second exemplary embodiment. In other words, during decoding of a final processing unit, it is possible to correctly decode even coded data generated by using the intra prediction mode of a processing unit outside the block for an intra prediction.

A fifth exemplary embodiment will be described. The above-described exemplary embodiments have been described, assuming that the respective operational units illustrated in FIGS. 1, 2, 7, and 8 are configured as hardware components. However, the processes performed by the respective operational units illustrated in FIGS. 1, 2, 7, and 8 may be realized by means of a computer program.

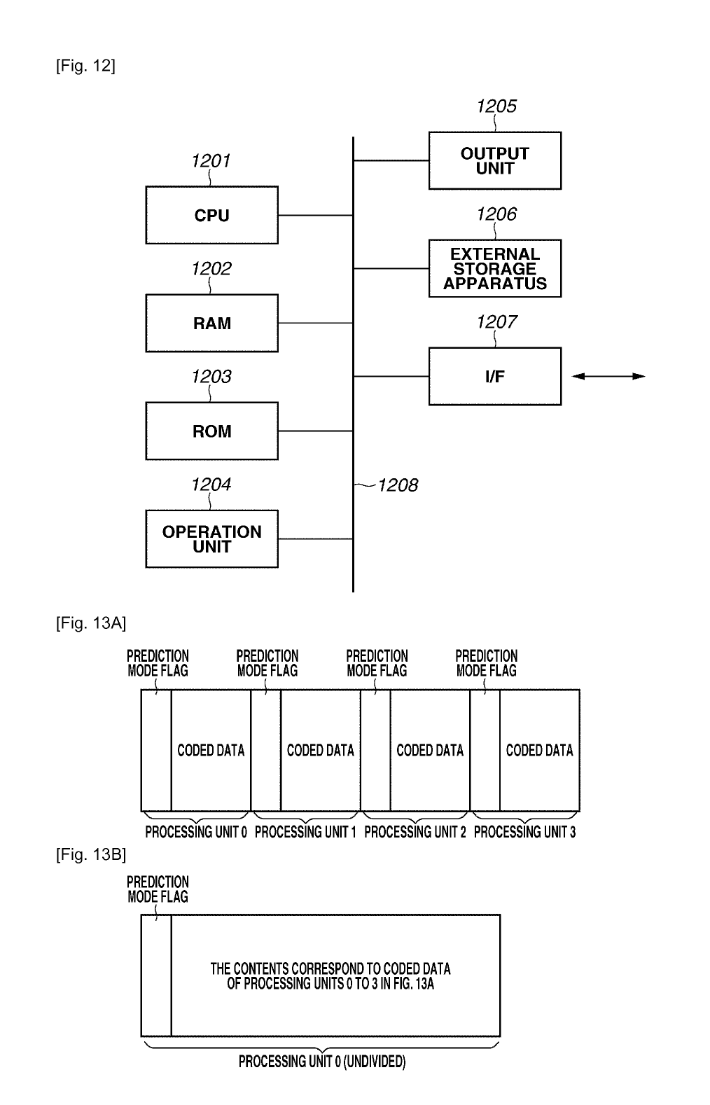

FIG. 12 is a block diagram illustrating an exemplary hardware configuration of a computer applicable to the image display apparatuses according to the above-described exemplary embodiments.

A central processing unit (CPU) 1201 controls an entire computer by using a computer program and data stored in a random access memory (RAM) 1202 and a read only memory (ROM) 1203, and also executes the respective processes that have been described above as processes to be performed by the image processing apparatuses according to the above-described exemplary embodiments. In other words, the CPU 1201 functions as the respective operational units illustrated in FIGS. 1, 2, 7, and 8.

The RAM 1202 has an area for temporarily storing, for example, a computer program and data loaded from an external storage apparatus 1206, and data acquired from the outside via an interface (I/F) 1207. Further, the RAM 1202 has a work area that the CPU 1201 uses during execution of various kinds of processes. In other words, for example, the RAM 1202 can be allocated as a frame memory, or provide other various kinds of areas as necessary.

The ROM 1203 stores, for example, the setting data of the present computer and a boot program. An operation unit 1204 includes a keyboard and a mouse, and can input various kinds of instructions to the CPU 1201 by a user's operation of the present computer. A display unit 1205 displays the result of processing performed by the CPU 1201. Further, the display unit 1205 includes, for example, a hold-type display apparatus such as a liquid crystal display or an impulse-type display apparatus such as a field emission type display apparatus.

The external storage apparatus 1206 is a mass information storage apparatus represented by a hard disc drive apparatus. The external storage apparatus 1206 stores an operating system (OS), and a computer program to allow the CPU 1201 to realize the functions of the respective units illustrated in FIGS. 1, 2, 7, and 8. Further, the external storage apparatus 1206 may store each image data which will be a processing target.

The computer program and data stored in the external storage apparatus 1206 are loaded to the RAM 1202 according to the control of the CPU 1201 as necessary, and are processed by the CPU 1201. A network such as a Local Area Network (LAN) and the Internet, and another apparatus such as a projection apparatus and a display apparatus can be connected to the I/F 1207. The present computer can acquire and transmit various kinds of information via the I/F 1207. A bus 1208 connects the above-described respective units to one another.

As the operations realized by the above-described configuration, the CPU 1201 plays a central role in controlling the operations illustrated in the above-described flowcharts.

Other exemplary embodiment will be described. Aspects of the present invention can be also achieved by supplying a storage medium storing codes of a computer program for realizing the above-described functions to a system, and causing the system to read and execute the codes of the computer program. In this case, the codes of the computer program read out from the storage medium realize the functions of the above-described exemplary embodiments, and the storage medium storing the codes of the computer program constitutes the present invention. Further, the embodiment also includes such a case that, for example, an operating system (OS) running on a computer executes a part or all of actual processing according to the instructions of the codes of the computer program, and this execution realizes the above-described functions.

Further, the present invention may be also realized in the following manner. The computer program codes read out from the storage medium are written into a memory provided to a function expansion card inserted into a computer or a function expansion unit connected to a computer. Then, for example, a CPU provided to the function expansion card or the function expansion unit executes a part or all of actual processing based on the instructions of the computer program codes to realize the above-described functions. Such a case is also included in the present invention.

When the present invention is applied to the above-described storage medium, the computer program codes corresponding to the above-described flowcharts are stored in the storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-004646 filed Jan. 13, 2011, which is hereby incorporated by reference herein in its entirety.

1. An image coding apparatus comprising:
a division unit configured to divide an input image into a processing target block;
a prediction mode determination unit configured, in units of the processing target block divided by the division unit, to determine a mode of an intra-picture prediction of the processing target block;
a holding unit configured to hold the intra prediction mode determined by the prediction mode determination unit;
a prediction mode estimation unit configured to estimate the intra prediction mode of the processing target block based on an intra prediction mode of a surrounding block around the processing target block, which is held by the holding unit;
a determination unit configured to determine whether the result of the prediction mode determination unit and the result of the prediction mode estimation unit match each other;
a coding unit configured to code the result of the determination unit, and further, when the result of the determination unit indicates a mismatch, to code the result of the prediction mode determination unit;
a mode comparison unit configured to acquire an intra prediction mode of one or more predetermined block surrounding the processing target block from the holding unit to compare the mode; and
a control unit configured to control the coding unit based on the result of the mode comparison unit.

2. The image coding apparatus according to claim 1,
wherein the mode comparison unit determines whether all of the intra prediction mode of the one or more predetermined block surrounding the processing target block match or do not match, and
wherein the control unit controls the coding unit based on the result of the determination of the mode comparison unit.

3. The image coding apparatus according to claim 2, wherein, in a case where the result of the determination of the mode comparison unit indicates a match, the control unit controls the coding unit so as not to code the result of the determination unit for a block to be processed last in processing of the one or more predetermined block according to a predetermined order.

4. The image coding apparatus according to claim 3, wherein, in a case where the result of the determination of the mode comparison unit indicates a mismatch, the control unit controls the coding unit so as to code the result of the determination unit for the block to be processed last in the processing of the one or more predetermined block according to the predetermined order.

5. An image decoding apparatus comprising:
a holding unit configured to hold a decoded intra prediction mode of each block;
a prediction mode estimation unit configured to acquire an intra prediction mode of one or more predetermined block surrounding a processing target block from the holding unit to estimate an intra prediction mode of the processing target block;
an intra prediction decoding unit configured to decode a mode estimation matching code, which indicates whether the intra prediction mode of the processing target block and the result of the prediction mode estimation unit match each other at the time of coding, and decode the intra prediction mode in a case where the result of the decoding indicates a mismatch;
a mode comparison unit configured to acquire the intra prediction mode of the one or more predetermined block surrounding the processing target block from the holding unit to compare the mode;
a block determination unit configured to determine whether the processing target block is a final processing block in a block; and
a control unit configured to control the intra prediction decoding unit based on the result of the mode comparison unit and the result of the block determination unit.

6. An image coding method comprising:
dividing an input image into processing target block(s);
determining a mode of an intra-picture prediction of the processing target block in units of the divided processing target block(s);
holding the prediction mode into a holding unit;
estimating the intra prediction mode of the processing target block based on the held intra prediction mode of a surrounding block around the processing target block;
comparing the result of the prediction mode determination and the result of the prediction mode estimation to determine whether they match each other;
coding the result of the comparison, and further, when the result of the comparison indicates a mismatch, coding the result of the prediction mode determination; and
acquiring and comparing an intra prediction mode of one or more predetermined block surrounding the processing target block from the holding unit,
wherein the coding is controlled based on the result of the mode comparison.

7. The image coding method according to claim 6,
wherein the mode comparing includes determining whether all of the intra prediction mode of the one or more predetermined block surrounding the processing target block match or do not match, and
wherein the controlling includes controlling the coding based on the result of the determination of the mode comparison.

8. The image coding method according to claim 7, wherein, in a case where the result of the determining the mode comparison indicates a match, the controlling includes controlling the coding so as not to code the result of the comparing for a block to be processed last in processing of the one or more predetermined block according to a predetermined order.

9. The image coding method according to claim 8, wherein, in a case where the result of the determination of the mode comparing indicates a mismatch, the controlling includes controlling the coding so as to code the result of the comparing for the block to be processed last in the processing of the one or more predetermined block according to the predetermined order.

10. An image decoding method comprising:
holding a decoded intra prediction mode of each block into a holding unit;
acquiring an intra prediction mode of one or more predetermined block surrounding a processing target block from the holding unit to estimate an intra prediction mode of the processing target block;
decoding a mode estimation matching code, which indicates whether the intra prediction mode of the processing target block and the result of the prediction mode estimation match each other at the time of coding, and decoding the intra prediction mode in a case where the result of the decoding indicates a mismatch;
acquiring the intra prediction mode of the one or more predetermined block surrounding the processing target block from the holding to compare the mode;
determining whether the processing target block is a final processing block in a block; and
controlling the intra prediction decoding based on the result of the mode comparing and the result of the block determining.

11. A storage medium storing an image coding program to perform operations comprising:
dividing an input image into processing target block(s);
determining a mode of an intra-picture prediction of the processing target block in units of the processing target block(s) divided by the dividing;
holding the prediction mode into a holding unit;
estimating the intra prediction mode of the processing target block based on the intra prediction mode of a surrounding block around the processing target block held in the holding unit;
comparing the result of the prediction mode determining and the result of the prediction mode estimating to determine whether they match each other;
coding the result of the comparing, and further, when the result of the comparing indicates a mismatch, coding the result of the prediction mode determining;
acquiring an intra prediction mode of one or more predetermined block surrounding the processing target block from the holding unit to compare the mode; and
controlling the coding based on the result of the mode comparing.

12. A storage medium storing an image decoding program to perform operations comprising:
holding a decoded intra prediction mode of each block into a holding unit;
acquiring an intra prediction mode of one or more predetermined block surrounding a processing target block from the holding unit to estimate an intra prediction mode of the processing target block as prediction mode estimation;
decoding a mode estimation matching code, which indicates whether the intra prediction mode of the processing target block and the result of the prediction mode estimation match each other at the time of coding, and decoding the intra prediction mode in a case where the result of the decoding indicates a mismatch;
acquiring the intra prediction mode of the one or more predetermined block surrounding the processing target block from the holding to compare the mode;
determining whether the processing target block is a final processing block in a block; and
controlling the intra prediction decoding based on the result of the mode comparing and the result of the block determining.
